(19) United States
(12) Patent Application Publication
(10) Pub. No.: US 2017/0061452 A1
(43) Pub. Date: Mar. 2, 2017

(54) SYSTEM FOR FORECASTING USING LOW-RANK MATRIX COMPLETION AND METHOD THEREFOR

(71) Applicant: WAL-MART STORES, INC., Bentonville, AR (US)

(72) Inventors: Ashin Mukherjee, Mountain View, CA (US); Shubhankar Ray, Union City, CA (US); Brian Seaman, San Francisco, CA (US)

(73) Assignee: WAL-MART STORES, INC., Bentonville, AR (US)

(21) Appl. No.: 14/841,448

(22) Filed: Aug. 31, 2015

(51) Int. Cl. G06Q 30/02; G06Q 10/08

(52) U.S. Cl. CPC G06Q 30/0202; G06Q 10/087

(57) ABSTRACT

A system and method of forecasting using low-rank matrix completion is presented. Sales data is gathered. The data is divided into four different matrices, with two matrices covering a similar time period one year apart and another matrix covering a time period of similar length to the time period to be forecast. Matrix completion methods are performed on the four matrices in various orders. Two matrices are combined to form one sub-problem, then two matrices are combined to form a second sub-problem. The two sub-problems are solved using a matrix completion method to create a forecast of the time period in question. The matrix completion method can involve solving a nuclear norm least squares problem, then using an expectation maximization algorithm to create a forecast. Other embodiments are also disclosed herein.

### TECHNICAL FIELD

This disclosure relates generally to forecasting and more particularly to forecasting sales using low-rank matrix completion.

### BACKGROUND

A retail business typically needs to stock items in a warehouse or physical store in order to sell the items. Storing too few of a particular item can be undesirable because if the item is sold out, then the retail business is not able to sell the item until it becomes in stock again. Storing too many of a particular item also can be undesirable because the amount of space in a warehouse or store is finite—storing too many of an item that does not sell takes away space from items that do sell. Therefore, it would be desirable to have a system that can more accurately forecast the sales of items for a retailer or distributor. In an electronic commerce (“eCommerce”) setting, the number of items sold by the retail business is much larger, but many items might not have enough sales to be accurately forecasted on their own. Hence there is a desire to have more accurate methodologies and systems for forecasting purposes.

### BRIEF DESCRIPTION OF THE DRAWINGS

To facilitate further description of the embodiments, the following drawings are provided in which:

FIG. 1 illustrates a front elevation view of a computer system that is suitable for implementing an embodiment of the system;

FIG. 2 illustrates a representative block diagram of an example of the elements included in the circuit boards inside a chassis of the computer system of FIG. 1;

FIG. 3 is a representative block diagram of a system according to an embodiment;

FIGS. 4A-4B illustrate an exemplary sales graph of a stock keeping unit;

FIG. 5 illustrates an exemplary low-rank matrix;

FIG. 6 is an illustration of data on which a forecast is desired;

FIG. 7 is a re-arranging of the data of FIG. 6 according to an embodiment;

FIG. 8 is a flowchart illustrating the operation of an embodiment; and

FIG. 9 is a block diagram illustrating a system capable of performing disclosed embodiments.

For simplicity and clarity of illustration, the drawing figures illustrate the general manner of construction, and descriptions and details of well-known features and techniques might be omitted to avoid unnecessarily obscuring the present disclosure. Additionally, elements in the drawing figures are not necessarily drawn to scale. For example, the dimensions of some of the elements in the figures might be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but might include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

In one embodiment, a method might comprise: receiving data corresponding to an overall time period; dividing the overall time period into a first time period, a second time period, a third time period, and a fourth time period, wherein: the first time period has a length identical to a length of the second time period; the third time period has a length identical to a length of the fourth time period; and the third time period is located between the first time period and the second time period; dividing the data into a first matrix A, a second matrix B, and a third matrix C; wherein, the first matrix A contains data for the first time period; the second matrix B contains data for the second time period; and the third matrix C contains data for the third time period; generating a fourth matrix D using matrix completion methods on the first matrix A, the second matrix B, and the third matrix C; and using the fourth matrix D to generate a forecast during the fourth time period.

In one embodiment, a system might comprise: one or more processing modules; and one or more non-transitory storage modules storing computing instructions configured to run on the one or more processing modules and perform the acts of: receiving data corresponding to an overall time period; dividing the overall time period into a first time period, a second time period, a third time period, and a fourth time period, wherein: the first time period has a length identical to a length of the second time period; the third time period has a length identical to a length of the fourth time period; and the third time period is located between the first time period and the second time period; dividing the data into a first matrix A, a second matrix B, and a third matrix C; wherein, the first matrix A contains data for the first time period; the second matrix B contains data for the second time period; and the third matrix C contains data for the third time period; generating a fourth matrix D using matrix completion methods on the first matrix A, the second matrix B, and the third matrix C; and using the fourth matrix D to generate a forecast during the fourth time period.

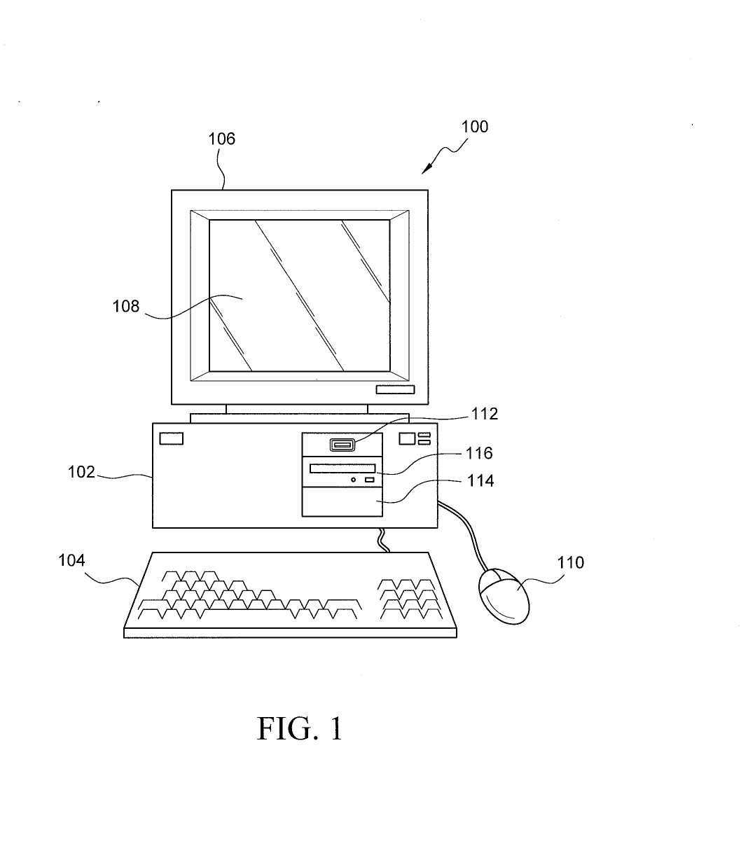

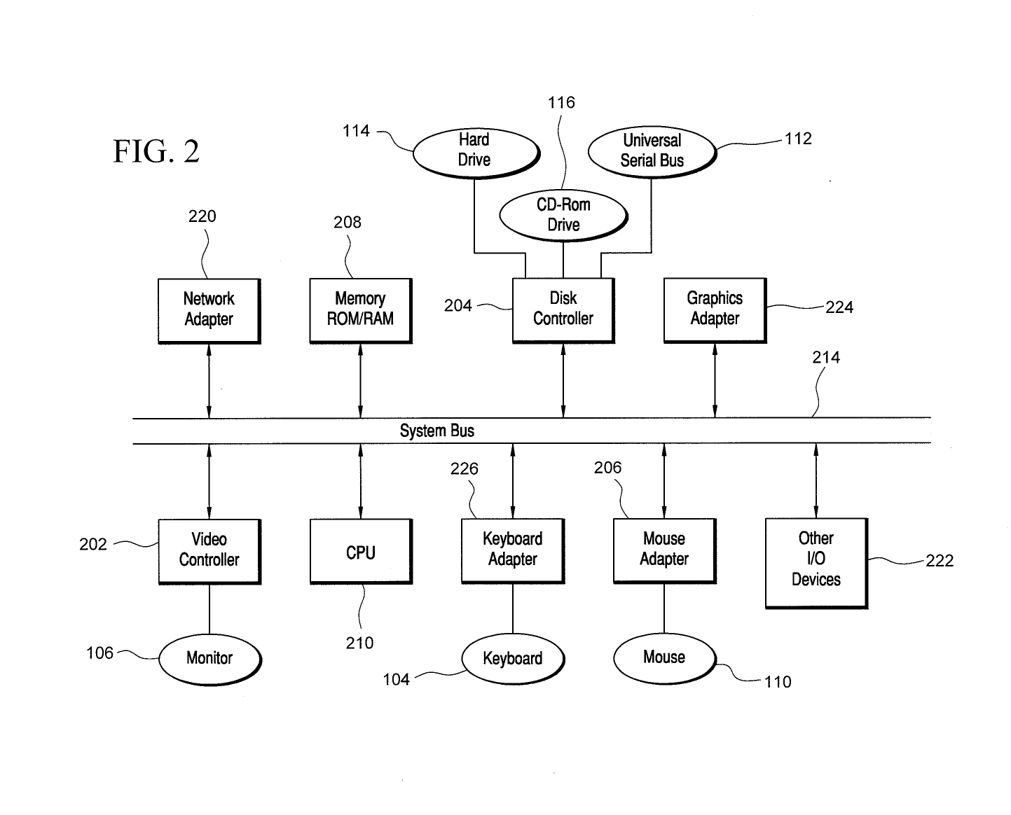

Turning to the drawings, FIG. 1 illustrates an exemplary embodiment of a computer system 100, all of which or a portion of which can be suitable for implementing the techniques described herein. As an example, a different or separate one of a chassis 102 (and its internal components) can be suitable for implementing the techniques described herein. Furthermore, one or more elements of computer system 100 (e.g., a refreshing monitor 106, a keyboard 104, and/or a mouse 110, etc.) also can be appropriate for implementing the techniques described herein. Computer system 100 comprises chassis 102 containing one or more circuit boards (not shown), a Universal Serial Bus (USB) port 112, a Compact Disc Read-Only Memory (CD-ROM), Digital Video Disc (DVD) drive, or Blu-ray drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 comprises both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can comprise microcode such as a Basic Input-Output System (BIOS) or Unified Extensible Firmware Interface (UEFI). In some examples, the one or more memory storage units of the various embodiments disclosed herein can comprise memory storage unit 208, a USB-equipped electronic device, such as, an external memory storage unit (not shown) coupled to universal serial bus (USB) port 112 (FIGS. 1-2), hard drive 114 (FIGS. 1-2), and/or CD-ROM, DVD drive, or Blu-ray drive 116 (FIGS. 1-2). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise various versions/distributions of Microsoft® Windows® operating system (OS), Apple® OS X, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

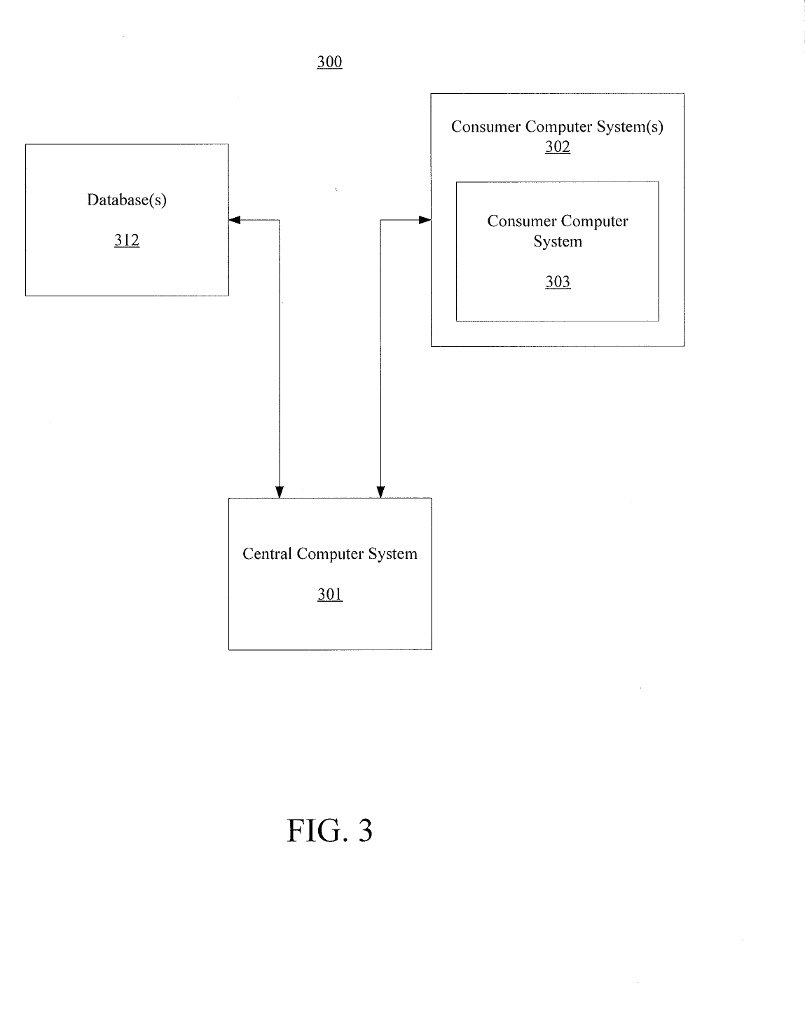

Skipping ahead now in the drawings, FIG. 3 illustrates a representative block diagram of a system 300, according to an embodiment. System 300 is merely exemplary and embodiments of the system are not limited to the embodiments presented herein. System 300 can be employed in many different embodiments or examples not specifically depicted or described herein. In some embodiments, certain elements or modules of system 300 can perform various methods and/or activities of those methods. In these or other embodiments, the methods and/or the activities of the methods can be performed by other suitable elements or modules of system 300.

As further described in greater detail below, in these or other embodiments, system 300 can proactively (e.g., prospectively) and/or reactively (e.g., responsively) determine and/or communicate the consumer product information to the consumer, as desired. Proactive acts can refer to acts (e.g., identification, determination, communication, etc.) performed without consideration of one or more predetermined acts performed by the consumer; and reactive acts can refer to acts (e.g., identification, determination, communication, etc.) performed with consideration of (i.e., in response to) one or more predetermined acts performed by the consumer. For example, in some embodiments, the predetermined act(s) can comprise an act of identifying a selection of a consumer product by the consumer.

Meanwhile, as also described in greater detail below, system 300 can be implemented in brick-and-mortar commerce and/or electronic commerce applications, as desirable. Further, in many of these or other embodiments, system 300 can communicate the consumer product information to the consumer substantially in real-time (e.g., near real-time). Near real-time can mean real-time less a time delay for processing (e.g., determining) and/or transmitting the relevant consumer product information to the relevant consumer. The particular time delay can vary depending on the type and/or amount of the consumer product information, the processing speed(s) of the processing module(s) of system 300, the transmission capability of the communication hardware (as introduced below), the transmission distance, etc. However, in many embodiments, the time delay can be less than approximately one, five, ten, or twenty minutes.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Specifically, system 300 comprises a central computer system 301. In many embodiments, central computer system 301 can be similar or identical to computer system 100 (FIG. 1). Accordingly, central computer system 301 can comprise one or more processing modules and one or more memory storage modules (e.g., one or more non-transitory memory storage modules). In these or other embodiments, the processing module(s) and/or the memory storage module(s) can be similar or identical to the processing module(s) and/or memory storage module(s) (e.g., non-transitory memory storage modules) described above with respect to computer system 100 (FIG. 1). In some embodiments, central computer system 301 can comprise a single computer or server, but in many embodiments, central computer system 301 comprises a cluster or collection of computers or servers and/or a cloud of computers or servers. Meanwhile, central computer system 301 can comprise one or more input devices (e.g., one or more keyboards, one or more keypads, one or more pointing devices such as a computer mouse or computer mice, one or more touchscreen displays, etc.), and/or can comprise one or more display devices (e.g., one or more monitors, one or more touchscreen displays, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) of central computer system 301 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of central computer system 301. In a similar manner, the processing module(s) and the memory storage module(s) can be local and/or remote to each other.

In many embodiments, central computer system 301 is configured to communicate with one or more consumer computer systems 302 (e.g., a consumer computer system 303) of one or more consumers. For example, the consumer(s) can interface (e.g., interact) with central computer system 301, and vice versa, via consumer computer system(s) 302 (e.g., consumer computer system 303). Accordingly, in many embodiments, central computer system 301 can refer to a back end of system 300 operated by an operator and/or administrator of system 300, and consumer computer system(s) 302 can refer to a front end of system 300 used by one or more users of system 300 (i.e., the consumer(s)). In these or other embodiments, the operator and/or administrator of system 300 can manage central computer system 301, the processing module(s) of computer system 301, and/or the memory storage module(s) of computer system 301 using the input device(s) and/or display device(s) of central computer system 301. In some embodiments, system 300 can comprise consumer computer system(s) 302 (e.g., consumer computer system 303).

Like central computer system 301, consumer computer system(s) 302 each can be similar or identical to computer system 100 (FIG. 1), and in many embodiments, each of consumer computer system(s) 302 can be similar or identical to each other. In many embodiments, consumer computer system(s) 302 can comprise one or more desktop computer devices, one or more wearable user computer devices, and/or one or more mobile devices, etc. At least part of central computer system 301 can be located remotely from consumer computer system(s) 302.

In some embodiments, a mobile device can refer to a portable electronic device (e.g., an electronic device easily conveyable by hand by a person of average size) with the capability to present audio and/or visual data (e.g., images, videos, music, etc.). For example, a mobile device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can comprise a volume and/or weight sufficiently small as to permit the mobile device to be easily conveyable by hand. For examples, in some embodiments, a mobile device can occupy a volume of less than or equal to approximately 189 cubic centimeters, 244 cubic centimeters, 1790 cubic centimeters, 2434 cubic centimeters, 2876 cubic centimeters, 4056 cubic centimeters, and/or 5752 cubic centimeters. Further, in these embodiments, a mobile device can weigh less than or equal to 3.24 Newtons, 4.35 Newtons, 15.6 Newtons, 17.8 Newtons, 22.3 Newtons, 31.2 Newtons, and/or 44.5 Newtons.

Exemplary mobile devices can comprise, but are not limited to, one of the following: (i) an iPod®, iPhone®, iPod Touch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia®, Surface Pro™, or similar product by the Microsoft Corporation of Redmond, Wash., United States of America, and/or (iv) a Galaxy™, Galaxy Tab™, Note™, or similar product by the Samsung Group of Samsung Town, Seoul, South Korea. Further, in the same or different embodiments, a mobile device can comprise an electronic device configured to implement one or more of (i) the iOS™ operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by Google, Inc. of Mountain View, Calif., United States, (v) the Windows Mobile™, Windows Phone™, and Windows 10 (mobile)™ operating systems by Microsoft Corporation of Redmond, Wash., United States of America, or (vi) the Symbian™ operating system by Nokia Corp. of Keilaniemi, Espoo, Finland.

In further embodiments, central computer system 301 can be configured to communicate with software (e.g., one or more web browsers, one or more mobile software applications, etc.) of the consumer computer system(s) 302 (e.g., consumer computer system 303). For example, the software can run on one or more processing modules and can be stored on one or more memory storage modules (e.g., one or more non-transitory memory storage modules) of the consumer computer system(s) 302 (e.g., consumer computer system 303). In these or other embodiments, the processing module(s) of the consumer computer system(s) 302 (e.g., consumer computer system 303) can be similar or identical to the processing module(s) described above with respect to computer system 100 (FIG. 1). Further, the memory storage module(s) (e.g., non-transitory memory storage modules) of the consumer computer system(s) 302 (e.g., consumer computer system 303) can be similar or identical to the memory storage module(s) (e.g., non-transitory memory storage module(s)) described above with respect to computer system 100 (FIG. 1). Exemplary web browsers can include (i) Firefox® by the Mozilla Organization of Mountain View, Calif., United States of America, (ii) Internet Explorer® by the Microsoft Corp. of Redmond, Wash., United States of America, (iii) Chrome™ by Google Inc. of Menlo Park, Calif., United States of America, (iv) Opera® by Opera Software of Oslo, Norway, and (v) Safari® by Apple Inc. of Cupertino, Calif., United States of America.

Meanwhile, in many embodiments, central computer system 301 also can be configured to communicate with one or more databases 312. The database can comprise a product database that contains information about products sold by a retailer. Database(s) 312 can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of database(s) 312, that particular database can be stored on a single memory storage module of the memory storage module(s) and/or the non-transitory memory storage module(s) storing database(s) 312 or it can be spread across multiple of the memory storage module(s) and/or non-transitory memory storage module(s) storing database(s) 312, depending on the size of the particular database and/or the storage capacity of the memory storage module(s) and/or non-transitory memory storage module(s).

In these or other embodiments, the memory storage module(s) of central computer system 300 can comprise some or all of the memory storage module(s) storing database(s) 312. In further embodiments, some of the memory storage module(s) storing database(s) 312 can be part of consumer computer systems 302 and/or one or more third-party computer systems (i.e., other than central computer system 301 and consumer computer systems 302), and in still further embodiments, all of the memory storage module(s) storing database(s) 312 can be part of consumer computer systems 302 and/or the third-party computer system(s). Like central computer system 301 and consumer computer system(s) 302, when applicable, each of the third-party computer system(s) can be similar or identical to computer system 100 (FIG. 1). Notably, the third-party computer systems are omitted from the drawings to better illustrate that database(s) 312 can be stored at memory storage module(s) of central computer system 301, consumer computer system(s) 302, and/or the third-party computer systems, depending on the manner in which system 300 is implemented.

Database(s) 312 each can comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between central computer system 301, consumer computer system(s) 302 (e.g., consumer computer system 303), and/or database(s) 312 can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), power-line network protocol(s), etc.). Exemplary PAN protocol(s) can comprise Bluetooth, Zigbee, Wireless Universal Serial Bus (USB), Z-Wave, etc. Exemplary LAN and/or WAN protocol(s) can comprise Data Over Cable Service Interface Specification (DOCSIS), Institute of Electrical and Electronic Engineers (IEEE) 802.3 (also known as Ethernet), IEEE 802.11 (also known as WiFi), etc. Exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, and the like. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.)

For convenience, the functionality of system 300 is described herein as it relates particularly to consumer computer system 303 and a single consumer. But in many embodiments, the functionality of system 300 can be extended to each of consumer computer system(s) 302 and/or to multiple consumers. In these extended examples, in some embodiments, single consumers can interface (e.g., interact) with central computer system 301 with multiple consumer computer systems of consumer computer system(s) 302 (e.g., at different times). For example, a consumer could interface with central computer system 301 via a first consumer computer system (e.g., a desktop computer), such as, for example, when interfacing with central computer system 301 from home, and via a second consumer computer system (e.g., a mobile device), such as, for example, when interfacing with central computer system 301 away from home.

Forecasting is a key problem encountered in inventory planning. In order to buy inventory in advance, retailers would like an estimate of the number of units a distinct item for sale (also known as a stock keeping unit or a “SKU”) is going to sell in a certain time period. To clarify the difference between an item and a SKU, an item might be, for example, an iPad. But each specific configuration of an iPad (screen size, memory size, color, radio, and the like) is a different SKU. Each SKU typically has a unique identifier, for ease of searching using a database.

Buying fewer units than is needed leads to lost sales opportunities, hence lower revenue, because items that could have been sold were not in stock. Buying too many units also can lead to lost sales opportunities because the cost of buying the unused inventory might not be compensated for by income from other sales to customers and can lead to lost opportunity costs (e.g., items that do not sell occupying space in a warehouse or store in place of items that could have been sold).

In general, a retailer wants to forecast the number of units it will sell, so it can accurately purchase the units on a timely basis. One method of forecasting examines past sales of an item. Past sales can reveal both local level and seasonal patterns. Local level patterns refer to sales in the recent past, as sales of a certain SKU in the recent past can be important in forecasting future sales. Seasonality refers to periodic events that can influence sales. Seasonality can refer both to general seasonality (e.g., sales are higher during the autumn because of the holiday season), and to product seasonality (some products are generally used only during certain times of the year.) For example, swimwear might be more popular in the spring and summer, while Christmas decorations are more popular in the fall and winter.

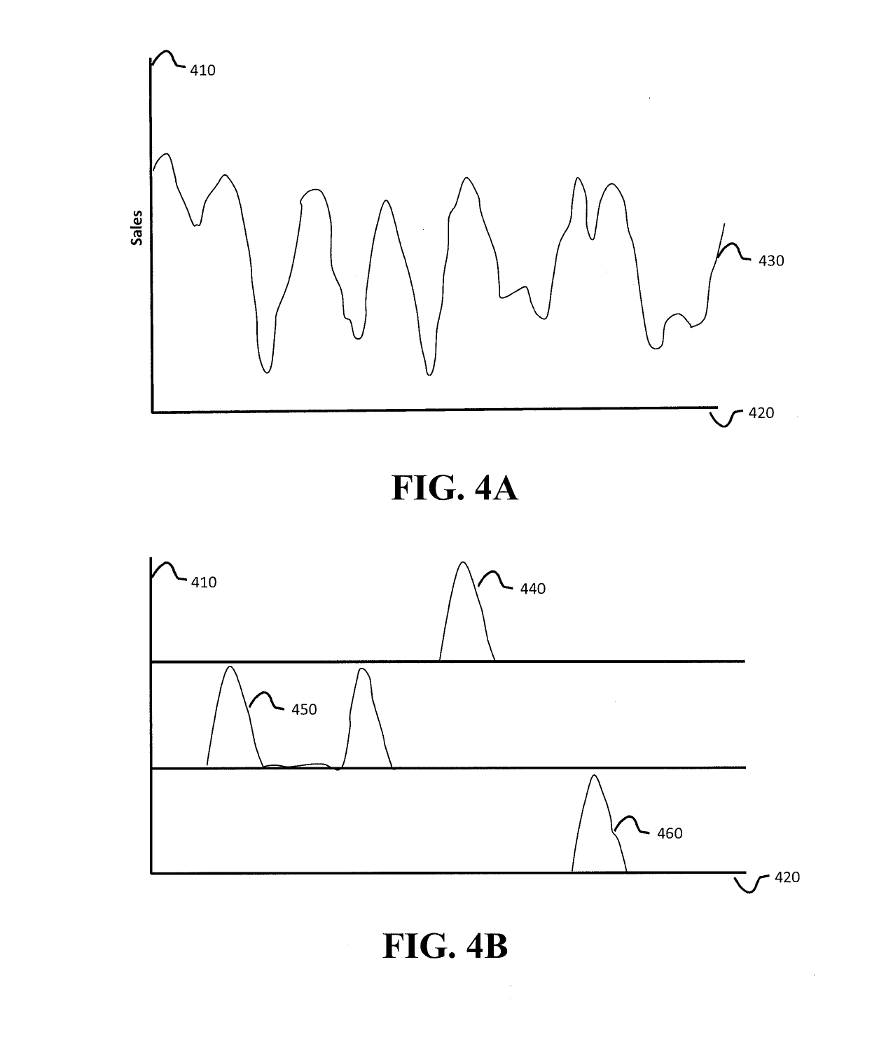

With reference to FIG. 4A, a graph illustrating the sales of an exemplary product is illustrated. X-axis 420 is the time period for the sales. For example, FIG. 4A could be an annual graph, and each time period is weekly sales. In another embodiment, FIG. 4A could be a multi-year graph, and each time period could be monthly sales. Other combinations are also possible.

Y-axis 410 is the range of values for sales. Data series 430 represents the sales for each time period represented by X-axis 420. Y-axis 410 can be in a variety of different formats. In some embodiments, Y-axis 410 can represent actual sales. In some embodiments, Y-axis 410 can represent sales rankings. Using rankings as opposed to actual sales might result in more reliable and accurate data in some embodiments. For modeling purposes, two time-series might be considered similar if they rise and fall in unison. A rank correlation metric such as a Pearson correlation or a Spearman correlation can be used to measure similarity between time-series. For display purposes, Y-axis 410 can be linear or logarithmic.

As described above, a retailer would take data such as that illustrated in FIG. 4A and use the data to predict future sales. If the graph is relatively periodic, the retailer can forecast that more of the sales would occur during a certain time of the year and that fewer sales would occur during other times of the year.

A few situations can occur that can make the use of such data to predict future sales difficult for some SKUs. For example, a possible situation can occur with electronic commerce (“eCommerce”) retailers. Because eCommerce retailers generally store more SKUs than brick and mortar stores, there might not be enough sales data to model each SKU separately. In addition, eCommerce retailers often stock SKUs that are short-lived or have erratic data. For example, some eCommerce retailers have SKUs that sell out quickly, and there exists a time period where there is no data. In an eCommerce situation, this can also occur when a retailer's website is down. In addition, there are SKUs that are short-lived, and thus there might not be available seasonal data from a previous year. Exemplary short-lived SKUs can include clothing (because of fashion trends, some items of clothing are sold only for a single season) and electronics (some forms of electronics, such as cell phone and TVs, are updated regularly, so a particular SKU might not have existed a year ago.) Another possible issue is high volatility. Many traditional time-series models expect the data to be relatively steady and are not as accurate for items with a high volatility such as items with high peaks such as back-to-school, holiday sales, and Black Friday sales.

FIG. 4B illustrates three different SKUs that have such situations. The same X-axis 420 and Y-axis 410 that are present in FIG. 4A also are present in FIG. 4B. Data series 440, data series 450, and data series 460 represent the sales of three different items. Data series 440 has incomplete data. Sales are present for only a very short time period, with no sales before or after that time period. This type of data series can be indicative of a short-lived item. Because the item had sales only for a very short-period of time, a popular but short-lived item might be indicative of a product that is no longer made. Data series 450 has two sales spikes, with a period of zero or otherwise low sales in between the sales spikes. Such a data series might be indicative of an item that could not keep up with demand (between the two spikes), and is no longer being made. Or such a data series might be indicative of a seasonal item (explaining the sales spikes) that is no longer being made (explaining the lack of data after the second sales spike). Data series 460 is similar to data series 440 in that it has only a single spike. However, while data series 440 is similar to data series 430 in that a peak for data series 430 roughly coincides with a peak of data series 440, data series 460 has a peak that roughly coincides with a trough of data series 430. This fact can indicate both that the item in data series 460 is a short-lived item and that its sales do not correlate well with the item represented by data series 430. This type of behavior is discussed in further detail below.

One method of solving the above problems is to forecast items in groups (also known as clusters). In other words, instead of forecasting what each individual SKU will sell, one would place a SKU in a group with other SKUs that have similar characteristics. Then, one forecasts what the group of SKUs would sell. Data series 430, data series 440, and data series 450 could be forecast as a group. The forecast could then be used to order the proper number of items for each of the three SKUs. While there are currently existing methods and systems for grouping SKUs, it would be desirable to have a more accurate method and system of grouping SKUs for forecasting purposes. Modeling in groups is also known as multivariate modeling.

There are several limitations on groups of SKUs that may be implemented. There should be both a lower-bound and an upper-bound on the number of SKUs in a group. A lower-bound can be desirable because too few SKUs in a group can result in one SKU adversely affecting the forecasting model by having a very large influence on a group. Too many SKUs in a group can be too large to compute efficiently. In some embodiments, an upper-bound is set at 200 SKUs per group.

In some traditional notions of grouping or clustering, there can be a requirement to place similar SKUs in the same groups. Thus, two similar items would not be placed in separate groups. However, in some embodiments, it is more important that dissimilar SKUs are not placed in the same group; similar items can be placed in separate groups, and embodiments will still operate correctly.

An example of dissimilar SKUs is seen in data series 430 of FIG. 4A and data series 460 of FIG. 4B. As explained above, while data series 430 goes down, data series 460 goes up. This fact can be an indication that placing the item represented in data series 430 in a group with the item represented in data series 460 might not be ideal.

One type of methodology used to perform multivariate forecasting is the use of time series models. There are many such methods using time-series models, including U.S. patent application Ser. No. 14/641,075, filed Mar. 6, 2015, incorporated herein by this reference. Such methods can use multiple models and find weights by fitting the models using cross-validation to determine an optimal solution. In addition, such methods often perform better with richer and less volatile past data. In contrast, embodiments presented herein can provide faster performance, can be simpler, and are not as adversely affected when used with sparse data.

Mathematically speaking, the problems to be solved can be expressed by placing data in matrices, then using matrix mathematics on the data. Let Matrix M be a p×q matrix containing information about sales per time period. There are p rows Mᵢ, each with a length q. Each row represents data about a certain SKU. Each column represents the sales data for a certain time period. The time periods can be a variety of different time periods. In some embodiments, the time period is a day. In some embodiments, the time period is a week (thus, each column would represent the sales of a particular week for each item).

A matrix can be factorized as follows:

M_{p×q}≈U_{p×r}V_{q×r}^{T}

In other words, the matrix M can be approximated by the multiplication of a matrix U, a p×r matrix, with matrix V, which is a q×r matrix.

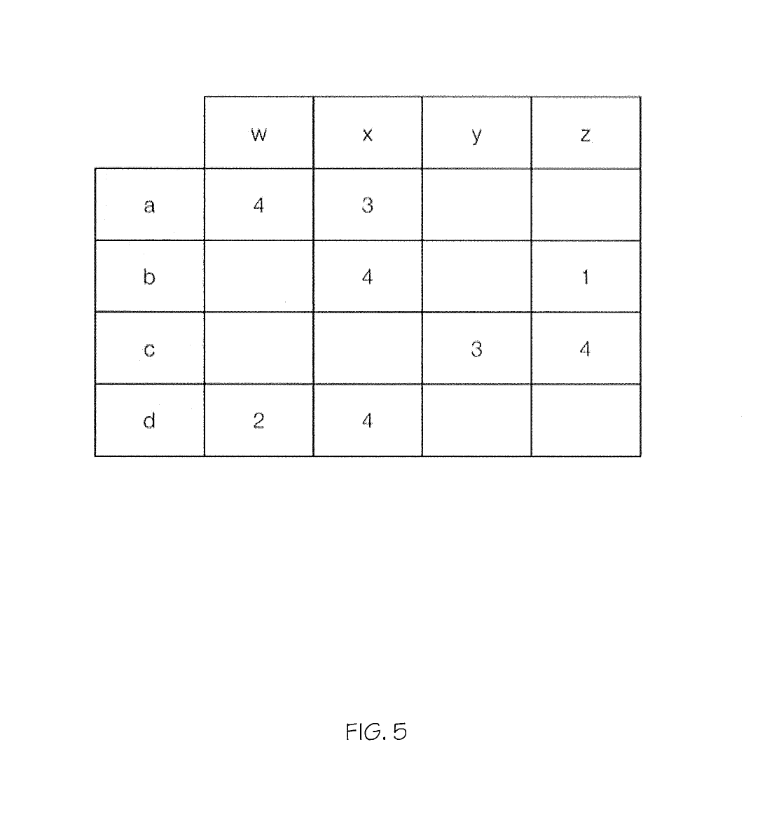

A low-rank has a structure that allows one to re-construct the matrix while observing a proportion of the entries, often significantly less than 1. This property is critical for imputing a matrix with many missing entries. An exemplary low-rank matrix is presented in FIG. 5. FIG. 5 shows matrix 500, which is a 4×4 matrix, meaning 4 rows 510 by 4 columns 520. However, while there are 16 possible entries in the 4×4 matrix, only 8 of the entries have actual data. The task of filling in a matrix based on a relatively small number of entries can be termed “matrix completion.” An example of matrix completion is the so-called “Netflix problem.” (See http://en.wikipedia.org/wiki/Netflix_Prize). In the Netflix problem, a large number of users rate a number of movies. However, the number of available movies is large and most users do not rate most movies. Thus, only approximately 1% of the matrix is complete. The Netflix problem involves the attempt to predict movies that a user would like based on the movies he has already rated. Many different matrix completion methods have been used to solve such a problem.

Matrix completion is the process of adding entries to a matrix that has some unknown or missing values. Matrix completion can be a difficult process and is made much more difficult for each piece of missing data. One method of performing a matrix completion is to use a technique called convex optimization.

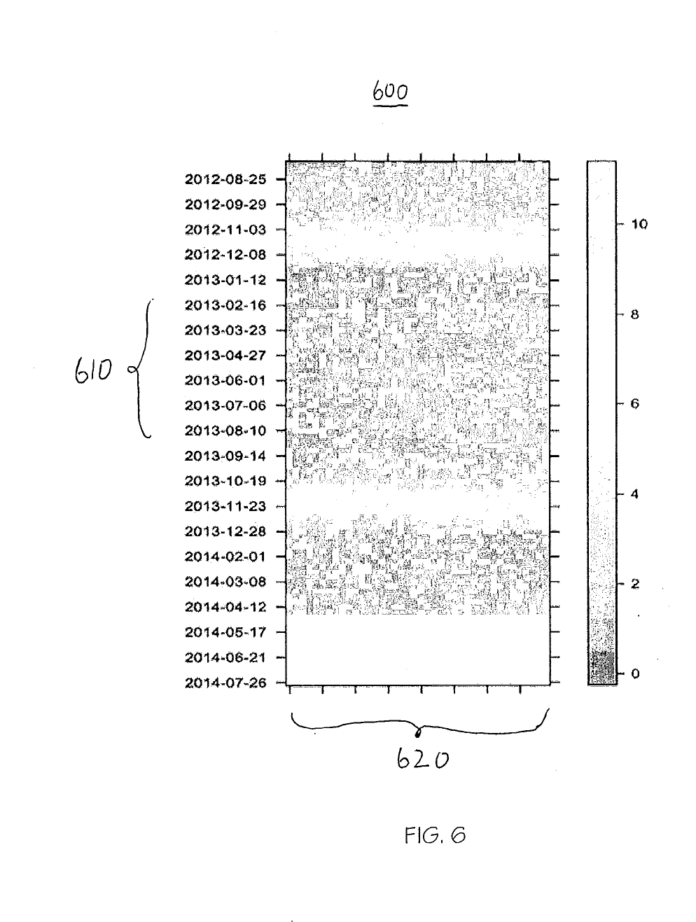

FIG. 6 illustrates an overview table 600 of the data on which it is desired to perform a forecast. The rows 610 represent sales data (or sales rank data) per week. The columns 620 of the matrices represent each SKU in a set to be forecast. Thus, the intersection of each row and column in table 600 represents sales per week. For illustration purposes, each intersection in table 600 is illustrated by a shaded block, with each shade representing a different amount of sales. However, for actual calculation purposes, actual sales numbers (or sales ranks) would be used.

In this example, forecasts involve 13-week periods, which represents one fiscal quarter. The goal when presented with FIG. 6 is to forecast the next 13-week period given the previous seven 13-week periods (one year plus three quarters). Using traditional methods, such a problem is difficult and time consuming to calculate. Moreover, the accuracy of traditional methods is dependent on how much data is missing.

Matrix completion methods could be used. However, while traditional matrix completion methods are usually effective at filling in missing data (e.g., blank spots within the first 39 weeks of FIG. 6), they are not as effective if large amounts of consecutive data is missing (e.g., the bottom 13 weeks of FIG. 6). Matrix completion algorithms also typically operate under the assumption that missing data is random, which is not true for the situation of FIG. 6—the entire bottom of the chart is missing, which is not random—it is the portion being solved for.

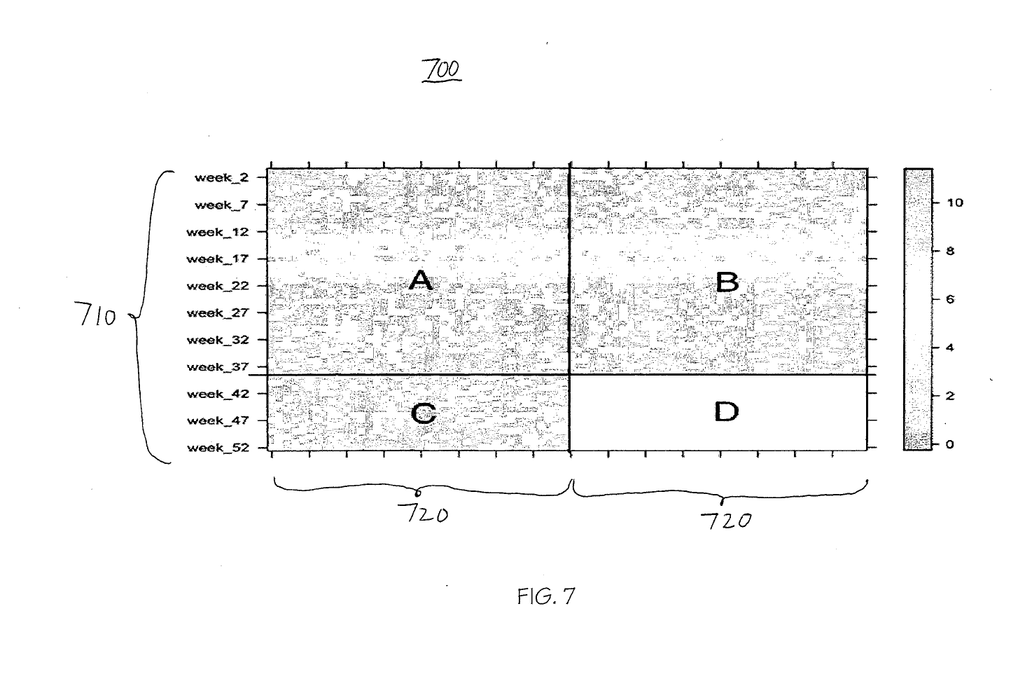

FIG. 7 is a method of re-arranging the data of FIG. 6 in such a manner that convex optimization and other matrix completion methods can be used. FIG. 7 contains rows 710 and columns 720. The data from FIG. 6 has been re-arranged such that like weeks from consecutive years are next to each other. In other words, week 1 from fiscal year 1 is next to week 1 from fiscal year 2. Each item has two data entries, one for fiscal year 1 and one for fiscal year 2.

Thereafter, the re-arranged data is divided into several different matrices. In the embodiment shown in FIG. 7, the result is a 39-week period that makes up matrix A. Matrix A thus comprises 39 rows of sales or sales rank data from fiscal year 1 and 40 columns of SKUs. Matrix B comprises 39 rows of sales or sales rank data from fiscal year 2 and 40 columns of SKUs (the same SKUs as Matrix A).

Matrix C contains 13 rows of sales or sales rank data from fiscal year 1 and 40 columns of SKUs, covering the 13 weeks immediately following the 39 weeks of data presented in Matrix A. Matrix D contains 13 rows of sales or sales rank data from fiscal year D and 40 columns of SKUs. However, Matrix D is empty—the goal is to estimate matrix D given matrices A, B, and C.

The data in matrices A, B, and C can contain some random missing data. However, enough data is present in each of matrices A, B, and C that various different matrix completion methods can be used on matrices A, B, and C, if one so desired. One also could combine the various matrices and perform a matrix completion algorithm. Some embodiments use one of a variety of different matrix completion algorithms (such as those discussed above) to solve for matrix D. Two sub-problems are calculated: a matrix completion for the following matrix:

(A B) (sub-problem 1)

and a matrix completion for the following matrix:

$$( \begin{matrix}A \\ C\end{matrix} ) \qquad ( sub \text{-} problem 2 )$$

A solution to sub-problem 1 generates the item similarity from the missing data (assuming that the missing data is approximately randomly distributed). A solution to the second sub-problem generates the seasonal profiles from the missing data. Multiplying the solution to sub-problem 1 with the solution to sub-problem 2 results in an estimate of matrix D, which results in forecast for the sales of each item in matrix D. Since each problem is a convex problem, the solution to each matrix completion is relatively simple to complete and can be performed quickly.

Although the above description discussed 13-week quarters, and 52-week fiscal years, it should be understood that other time frames can be used in various embodiments. For example, 26-week periods and 104 week periods can be used. Periods smaller than a year also can be used, however, it might be desirable to use time frames that include pertinent peaks and valleys of sales seasons (e.g., Black Friday sales).

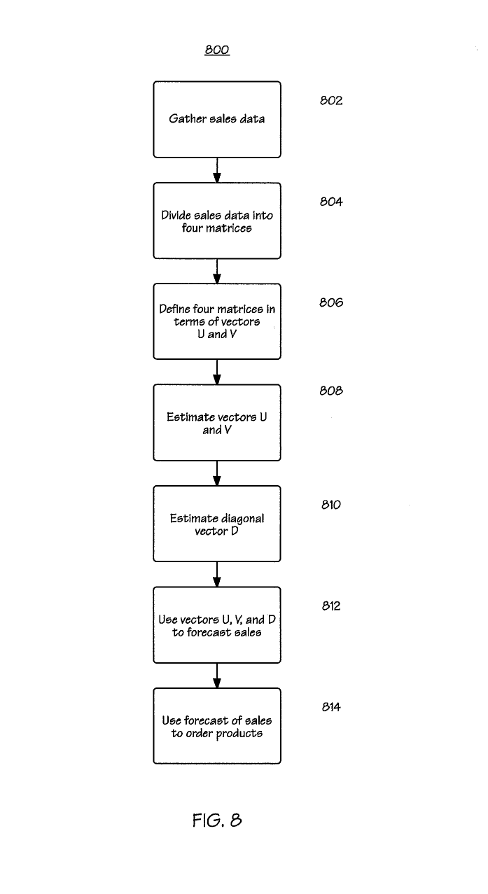

With the overall theory of a solution provided above, FIG. 8 will now show a flowchart illustrating the operation of a method 800 of initializing the clusters of a clustering algorithm is disclosed. Method 800 is merely exemplary and is not limited to the embodiments presented herein. Method 800 can be employed in many different embodiments or examples not specifically depicted or described herein. In some embodiments, the procedures, the processes and/or the activities of method 800 can be performed in the order presented. In other embodiments, the procedures, the processes, and/or the activities of method 800 can be performed in any other suitable order. In still other embodiments, one or more of the procedures, the processes, and/or the activities of method 800 can be combined or skipped. In some embodiments, method 800 can be implemented by computer system 100 (FIG. 1).

Sales data from an overall time period are gathered or received (block 802). The data is divided into four different matrices as described above (block 804). This can involve dividing the overall time period into four different time periods—a first time period, a second time period, a third time period, and a fourth time period. The first time period and the second time period can have lengths that are substantially identical to each other. The third time period and the fourth time period can have lengths that are substantially identical to each other. The third time period can be located between the first time period and the second time period. In some embodiments, the third time period does not overlap with the first or second time periods. In the same or different embodiments, the third time period is immediately adjacent or contiguous with the first and second time periods. In other embodiments, the third time period overlaps with one or more of the first or second time periods, and/or the third time period is spaced apart in time from one or more of the first or second time periods.

The data can be divided into matrices based on the time periods. For example, a first matrix A contains data of a certain group of SKUs for a first time period, and a second matrix B contains data of a the same group of SKUs for the second time period. A third matrix C can contain data of the same group of SKUs for a third time period. A fourth matrix D can contain the data to be solved. In some embodiments, fourth matrix D can comprise the same group of SKUs at a time period of the same length of time as the third time period and directly after the second time period.

The fourth matrix D is generated using data from first matrix A, second matrix B, and third matrix C. The generation of fourth matrix D can be accomplished using matrix completion methods on first matrix A, second matrix B, and third matrix C. To elaborate on the matrix completion methods, a vector U and a vector V can be defined as follows:

U=(U₁ U₂)

V=(V₁ V₂)

The goal is to find the following:

$$M \approx ( \begin{matrix}{U}_{1} {V}_{1}^{T} & {U}_{1} {V}_{2}^{T} \\ {U}_{2} {V}_{1}^{T} & {U}_{2} {V}_{2}^{T}\end{matrix} )$$

Thereafter, the first through fourth matrices described above are defined in terms of U and V as follows (block 806):

A=(U₁ V₁)

B=(U₂ V₂)

C=(U₂ V₁)

D=(U₂ V₂)

Thereafter, vectors U and V are estimated (block 808). In some embodiments, vector V is a right singular vector of the following sub-problem:

(A B)

In some embodiments, matrix U is a left singular vector of the following sub-problem:

$$( \begin{matrix}A \\ C\end{matrix} )$$

Vectors U and V can be solved in a variety of different methods. In some embodiments, a nuclear norm penalized least squares problem over the observed entries of the matrix is calculated. The problem can be expressed as follows:

min_{Z}∥P_{Ω}(M−Z)∥_{F}²+λ∥Z∥_{*}

Where P is a projection matrix over the set of observed entries of M. It computes the difference of M and Z on the entries on which M was observed.

In other words, one tries to find the minimum value of Z that satisfies the above-listed equation. The above-listed equation is a convex problem that obtains a global optimum solution. A singular value thresholding algorithm, such as the SoftImpute algorithm, can be used in some embodiments to obtain the solution. The SoftImpute algorithm is disclosed in the following paper: Mazumder, Rahul et al., “Spectral Regularization Algorithms for Learning Large Incomplete Matrices,” Journal of Machine Learning Research 11 (2010), incorporated herein by this reference. A software version of the algorithm is available at: http://cran.r-project.org/web/packages/softImpute/index.html. Other algorithms also can be used, including the HardImpute algorithm described in the same paper, and various references cited in the Mazumder paper.

The SoftImpute algorithm is an iterative process that decreases the value of an objective function towards its minimum with each iteration. The algorithm can be summarized as follows. First, the Z variable is initialized at zero:

Z^{old}=0

Thereafter, for each value of λ, repeat the following three steps:

(i) Compute Z^{new}←S_{λ}_{ₖ}(P_{Ω}(X)+ [symbol] (Z^{old}));

$$if \\ \frac{{‖ {Z}^{new} - {Z}^{old} ‖}_{F}^{2}}{{‖ {Z}^{old} ‖}_{F}^{2}} < ɛ , \qquad ( ii )$$

then exit;

(iii) assign Z^{old}←Z_{new};

Assign \hat{Z}_{λ}_{ₖ}←Z^{new}

Finally, output the sequence of solutions \hat{Z}_{λ}_{₁} . . . \hat{Z}_{λ}_{ₖ}.

An ordinary least squares (OLS) algorithm can be used to estimate a diagonal vector d (block 810). Diagonal vector d is a scaling factor that allows comparisons to be made between products with different sales figures (e.g., sales of 30 in a specific time period for a first product versus sales of 7,000 during the same time period for a second product.) The estimated d vector gives the weight for each column of U and V. It is absorbed in U and V as the square root of d for notational simplicity.

The result is a matrix D. Matrices U, V, and D are combined to create a sales forecast for the fourth time period (block 812). In an eCommerce situation, the estimate for sales during the fourth time period can be used to order products (block 814).

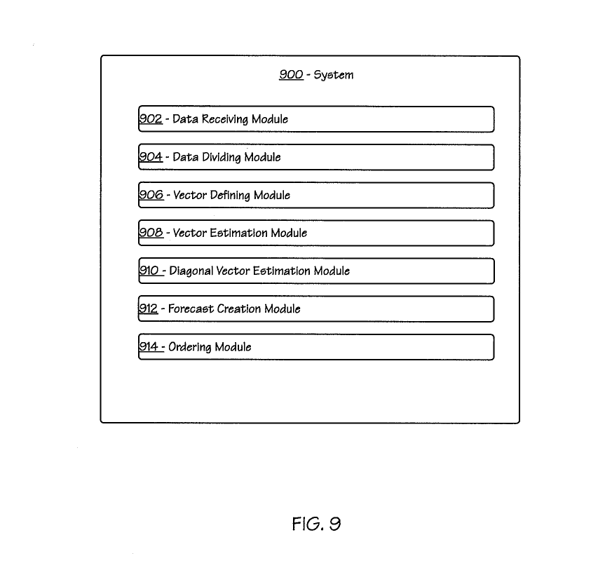

Turning ahead in the figures, FIG. 9 illustrates a block diagram of a system 900 that is capable of performing disclosed embodiments. System 900 is merely exemplary and is not limited to the embodiments presented herein. System 900 can be employed in many different embodiments or examples not specifically depicted or described herein. In some embodiments, certain elements or modules of system 900 can perform various procedures, processes, and/or acts. In other embodiments, the procedures, processes, and/or acts can be performed by other suitable elements or modules.

In a number of embodiments, system 900 can include data receiving module 902. In certain embodiments, initial medoid choosing module 902 can perform block 802 (FIG. 8) of receiving sales data.

System 900 can data dividing module 904. In certain embodiments, data dividing module 904 can perform block 804 (FIG. 8) of dividing the received sales data into four matrices.

System 900 can include vector defining module 906. In certain embodiments, vector defining module 906 can perform block 806 (FIG. 8) of defining the four matrices in terms of vectors U and V.

System 900 can include vector estimation module 908. In certain embodiments, vector estimation module 908 can perform block 808 (FIG. 8) of estimating vectors U and V.

System 900 can include diagonal vector estimation module 910. In certain embodiments, diagonal vector estimation module 910 can perform block 810 (FIG. 8) of estimating a diagonal vector D.

System 900 can include forecast creation module 912. In certain embodiments, forecast creation module 912 can perform block 812 (FIG. 8) of creating a sales forecast based on vectors U, V, and D.

System 900 can include ordering module 914. In certain embodiments, ordering module 914 can perform block 814 (FIG. 8) of ordering items based on the sales forecast.

Although the above embodiments have been described with reference to eCommerce situations and forecasts for sales or demand, it should be understood that the methods and systems described herein could be applied to any type of situation in which one wishes to forecast unknown data.

Although the above embodiments have been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-9 can be modified, and that the foregoing discussion of certain of these embodiments does not necessarily represent a complete description of all possible embodiments. For example, one or more of the procedures, processes, or activities of FIGS. 1-9 can include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processing modules; and
one or more non-transitory storage modules storing computing instructions configured to run on the one or more processing modules and perform the acts of:
receiving data corresponding to an overall time period;
dividing the overall time period into a first time period, a second time period, a third time period, and a fourth time period, wherein:
the first time period has a length identical to a length of the second time period;
the third time period has a length identical to a length of the fourth time period; and
the third time period is located between the first time period and the second time period;
dividing the data into a first matrix A, a second matrix B, and a third matrix C; wherein,
the first matrix A contains data for the first time period;
the second matrix B contains data for the second time period; and
the third matrix C contains data for the third time period;
generating a fourth matrix D using matrix completion methods on the first matrix A, the second matrix B, and the third matrix C; and
using the fourth matrix D to generate a forecast during the fourth time period.

2. The system of claim 1 wherein:
the data comprises sales data; and
the computing instructions are further configured to run on the one or more processing modules and perform the additional acts of:
ordering products based on the forecast during the fourth time period.

3. The system of claim 1 wherein the computing instructions are further configured to run on the one or more processing modules and perform the acts of:
estimating a fifth matrix U using the first matrix A and the third matrix C;
estimating a sixth matrix V using the first matrix A and the second matrix B; and
using fifth matrix U and sixth matrix V to generate the fourth matrix D.

4. The system of claim 3 wherein:
estimating the fifth matrix U comprises using a matrix completion algorithm to estimate the fifth matrix U; and
estimating the sixth matrix V comprises using a matrix completion algorithm to estimate the sixth matrix V.

5. The system of claim 3 wherein:
estimating the fifth matrix U using the first matrix A and the third matrix C comprises solving a sub-problem
$$( \begin{matrix}A \\ C\end{matrix} ) ;$$
and
estimating the sixth matrix V using the first matrix A and the second matrix B comprises solving a sub-problem (A B).

6. The system of claim 5 wherein:
solving the sub-problem
$$( \begin{matrix}A \\ C\end{matrix} )$$
comprises calculating a first nuclear norm penalized least squares problem; and
solving the sub-problem (A B) comprises calculating a second nuclear norm penalized least squares problem.

7. The system of claim 6 wherein:
calculating the first nuclear norm penalized least squares problem comprises using a singular value thresholding algorithm; and
calculating the second nuclear norm penalized least squares problem comprises using the singular value thresholding algorithm.

8. The system of claim 7 wherein the singular value thresholding algorithm is a SoftImpute algorithm.

9. The system of claim 7 wherein the singular value thresholding algorithm comprises solving the following equation: min_{Z}∥P_{Ω}(M−Z)∥_{F}²+λ∥Z∥_{*}.

10. The system of claim 3 wherein the computing instructions are further configured to run on the one or more processing modules and perform the acts of:
using an ordinary least squares technique to estimate a weighting for the fifth matrix U and the sixth matrix V.

11. A method comprising:
receiving data corresponding to an overall time period;
dividing the overall time period into a first time period, a second time period, a third time period, and a fourth time period, wherein:
the first time period has a length identical to a length of the second time period;
the third time period has a length identical to a length of the fourth time period; and
the third time period is located between the first time period and the second time period;
dividing the data into a first matrix A, a second matrix B, and a third matrix C; wherein,
the first matrix A contains data for the first time period;
the second matrix B contains data for the second time period; and
the third matrix C contains data for the third time period;
generating a fourth matrix D using matrix completion methods on the first matrix A, the second matrix B, and the third matrix C; and
using the fourth matrix D to generate a forecast during the fourth time period.

12. The method of claim 11 wherein:
the data comprises sales data; and
the method further comprises:
ordering products based on the forecast during the fourth time period.

13. The method of claim 11 further comprising:
estimating a fifth matrix U using the first matrix A and the third matrix C;
estimating a sixth matrix V using the first matrix A and the second matrix B; and
using fifth matrix U and sixth matrix V to generate the fourth matrix D.

14. The method of claim 13 wherein:
estimating the fifth matrix U comprises using a matrix completion algorithm to estimate the fifth matrix U; and
estimating the sixth matrix V comprises using a matrix completion algorithm to estimate the sixth matrix V.

15. The method of claim 13 wherein:
estimating the fifth matrix U using the first matrix A and the third matrix C comprises solving a sub-problem
$$( \begin{matrix}A \\ C\end{matrix} )$$
and
estimating the sixth matrix V using the first matrix A and the second matrix B comprises solving a sub-problem (A B).

16. The method of claim 15 wherein:
solving the sub-problem
$$( \begin{matrix}A \\ C\end{matrix} )$$
comprises calculating a first nuclear norm penalized least squares problem; and
solving the sub-problem (A B) comprises calculating a second nuclear norm penalized least squares problem.

17. The method of claim 16 wherein:
calculating the first nuclear norm penalized least squares problem comprises using a singular value thresholding algorithm; and
calculating the second nuclear norm penalized least squares problem comprises using the singular value thresholding algorithm.

18. The method of claim 17 wherein the singular value thresholding algorithm is a SoftImpute algorithm.

19. The method of claim 17 wherein the singular value thresholding algorithm comprises solving the following equation: min_{Z}∥P_{Ω}(M−Z)∥_{F}²+∥Z∥_{*}.

20. The method of claim 13 further comprising:
using an ordinary least squares technique to estimate a weighting for the fifth matrix U and the sixth matrix V.
